(19) United States
(12) Patent Application Publication
(10) Pub. No.: US 2009/0287456 A1
(43) Pub. Date: Nov. 19, 2009

(54) Distributed Sensor System

(76) Inventors: Steve Tran, Houston, TX (US); Royal King, Magnolia, TX (US); David Moore, Tomball, TX (US); Allen Morrison, Tomball, TX (US); Stewart Nguyen, Houston, TX (US); Ratnesh Sharma, Fremont, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/244,096

(22) Filed: Oct. 2, 2008

Related U.S. Application Data
(60) Provisional application No. 61/052,714, filed on May 13, 2008.

(51) Int. Cl. G06F 15/16; G06F 15/00

(52) U.S. Cl. 702/188; 709/202

(57) ABSTRACT

A distributed sensor system includes a plug-in attachment, the plug-in attachment having a memory and at least one sensor; a modular node, the plug-in attachment being configured to connect to the modular node, the modular node being configured to read the memory and receive sensor data from the at least one sensor; a network, the network being connected to the modular node; and a central processor, the central processor being connected to the network and being in communication with the modular node through the network. A method for configuring and using a distributed sensor system includes connecting at least one plug-in assembly to a modular node, the at least one plug-in assembly having a memory and at least one sensor, the memory containing configuration data; connecting the modular node and a central processor to a network; configuring the modular node via the network; the modular node retrieving the configuration data and sending the configuration data via the network to the central processor; the modular node receiving sensor data from the at least one sensor, the modular node transmitting the sensor data via the network to the central processor.

### CROSS REFERENCE TO RELATED APPLICATIONS

This application claims the benefit of provisional patent application Ser. No. 61/052,714, filed May 13, 2008, titled “Distributed Sensor System.”

### BACKGROUND

Distributed sensor systems are often used to collect data from many physically distinct locations and transmit the data to a central location for processing and decision making. Consequently, a distributed sensor system is typically made up of a population of distributed sensors, a communication network, and one or more centralized processors.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram of a single wire based data collection system, according to one illustrative embodiment of the principles described herein.

FIG. 2 is a diagram of a data collection system, according to one illustrative embodiment of the principles described herein.

FIG. 3 is a diagram of a data collection assembly, according to one illustrative embodiment of the principles described herein.

FIG. 4 is a diagram of communication between the modular nodes and the central data collector, according to one illustrative embodiment of the principles described herein.

FIG. 5 is a flow chart which depicts the data collection procedure for a modular node, according to one illustrative embodiment of the principles described herein.

FIG. 6 is a flow chart which depicts the modular node's watchdog process, according to one illustrative embodiment of the principles described herein.

FIG. 7 is a flow chart which depicts the modular node's command receiving process, according to one illustrative embodiment of the principles described herein.

FIG. 8 is a flow chart which depicts message receiving process of the central data collector, according to one illustrative embodiment of the principles described herein.

FIG. 9 is a flow chart showing one illustrative method of assembling and using a distributed data collection system, according to one illustrative embodiment of the principles described herein.

Throughout the drawings, identical reference numbers designate similar, but not necessarily identical, elements.

### DETAILED DESCRIPTION

The following specification presents a method and system for gathering data from a large number of sensors spread over a large area with minimal time and effort required for setup and installation. According to one illustrative embodiment, the system is made up of several modular nodes which collect data through attached sensors, a network over which data is sent, and a central data collector which receives and organizes data from the modular nodes. Modular nodes are smart and can manage multiple sensors, receive configuration instructions from the central data collector, and verify proper system operation.

Instructions and data may be sent between the modular nodes and the central data collector through Internet Protocol (IP) multicasting. IP multicasting allows a single communication channel to be used to communicate with a large number of listeners. In this example messages may be sent over the network formatted in eXtensible Markup Language (XML). The illustrative system and method are described in greater detail below.

As introduced, distributed sensor systems are often used to collect data from many physically distinct locations and transmit the data to a central location for processing and decision making. Consequently, a distributed sensor system is typically made up of sensors, a communication network, and one or more centralized processors.

The sensors in the system produce the data that is sent to the central processor. A sensor can be any device that converts environmental conditions into a signal readable by humans or some other device. A sensor could be a temperature sensor, motion detector, speed sensor, light meter, pH meter, or any other transducer that transforms one form of energy into another. In a distributed sensor system, sensors are typically placed at each location where data is to be collected.

The sensors are connected to a communication network through which collected data is transferred to the central data collector or processor. The communication network can be any system of connections, either wired or wireless, that allows transmission of data from one location to another.

The central data collector or central processor can be any device that is capable of receiving the data from the population of sensors and processing the data to produce a desired result, whether a decision, a record of variables tracked by the sensors or some other result. For example, the desired result may be something as simple as controlling the temperature in a room. The central processor may be, for example, a computer, an Application Specific Integrated Circuit (ASIC), a microcontroller or any other processor.

One advantage of distributed sensor systems is that they allow data to be rapidly collected from different locations and thus reduce the cost and complexity of collecting and processing large amounts of data. Distributed sensor systems may also allow the central data collector or processor to receive data corresponding to multiple variables that influence a desired objective or outcome.

However, conventional distributed sensor systems present some previously unresolved issues. For example, many current distributed sensor systems require dedicated wiring for the communication network which increases the cost of installation, makes the system difficult to relocate, restricts the size of the deployment area, and limits the number of sensors that can be deployed in the system. Communication is also typically limited to data sent from the sensors to the processor, making it difficult to mass-configure sensors and verify that data was transferred correctly. Finally, the format of messages sent over the network from the sensors is generally set and inflexible, making future upgrades to new sensor types prohibitively expensive and time-consuming.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

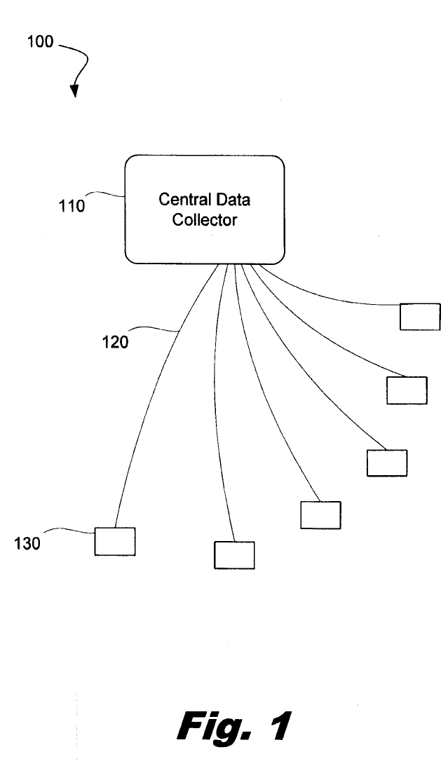

FIG. 1 is a diagram of a data collection system (100) comprising a central data collector (110), a series of communication cables (120), and one or more sensors (130). Each cable (120) may provided both power to the corresponding sensor (130) and communication between that sensor (130) and the central data collector (110). Additionally, the practical length of each cable (120) may be limited because longer cables have greater resistance from end to end. This resistance weakens signals as they travel along the cable. Beyond a certain length, signals become too weak to be reliably received by the central data collector (110).

As shown in FIG. 1, multiple cables (120) are attached to the same central data collector (110). Without additional hardware and increased expense, the simplest way for the central data collector to read the sensors in this configuration is polling. When polling, the central data collector requests data from each sensor, one at a time, until all sensors are read. This is a simple, inexpensive method, but is also an inefficient use of time. Polling causes the central data collector to spend a large percentage of time waiting for each individual sensor to send data. As the number of sensors increases, the time needed to read all the sensors increases proportionally. Thus, a large number of sensors on a single network is achieved at the expense of temporal resolution of the data being collected. In order to keep the time between data collection cycles small, the number of sensors on the network may be limited.

In the following specification, some of the issues of high installation cost, system size limitations, and sensor number limits may be addressed by using an Ethernet based communication network between distributed sensors and a central processor. Ethernet is a commonly used standard for wired networking. An Ethernet network typically includes an Ethernet cable to each device on the network. Each cable runs to a piece of network hardware, such as a hub, that manages communication. Each hub can also be connected to one or more additional hubs or other network hardware.

Since Ethernet is widely used, many places where a distributed sensor system might be installed may already have wiring for an Ethernet network in place. Using the existing network decreases the cost of installation and makes it easier to relocate the system to another site if necessary. Since communication between devices on an Ethernet network can pass through multiple hubs, wire length limits for a single Ethernet cable do not tend to restrict the size of the network. This increases the size of the area that a distributed sensor system can cover.

Ethernet also allows communication with multiple devices at the same time. Consequently, sensors do not have to wait their turn during a polling operation to send data to a central processor. Thus, resources that would otherwise be used for polling, can be used for processing data. This allows more sensors to be placed on a single network.

Thus, Ethernet allows a distributed sensor system to be more easily installed and relocated, increases the physical size limits of the system, and allows more sensors to be on a single network.

The sensors in conventional distributed sensor systems typically do not receive data or instructions from the central processor. Thus, such sensors cannot be configured remotely. Configuration is either done manually for each sensor or through additional configuration equipment at setup time. This increases the time and cost of installing the system. One-way communication from the sensor to the central processor also makes it difficult to verify the proper transfer of data.

In the description below, these issues are addressed by using smart modular nodes attached to the sensors. These smart modular nodes both send data gathered from the sensors and receive data from the central processor. Being able to receive instructions from the central processor allows the modular nodes and attached sensors to be configured from the central processor. This greatly reduces both setup time and the cost of installing a distributed sensor system. The central processor can also send messages confirming that data was received, enabling the modular node to verify proper operation of the system. Thus, smart modular nodes allow two-way communication between the sensors and the central processor thereby simplifying sensor configuration and providing verification that data was transferred correctly.

As noted above, in conventional distributed sensor systems, the format of data messages sent to the central processor is in a fixed format. Fixed format messages have a fixed length with data located at a specific location within the message. If changes or upgrades are made, or new types of sensors are added to the network, the format of the message may need to be changed. As a result, the central processor may need to be reprogrammed in order to read messages in the new format.

In the following specification, this issue is addressed by encoding messages from the sensors in eXtensible Markup Language (XML). For example, the smart modular node encodes the sensor data in XML for transmission to the central processor. XML is a common standard that allows any type or amount of data to be encoded in a single XML document. This provides flexibility for future upgrades to the distributed sensor system. When messages are encoded in XML, the central processor does not have to be reprogrammed to be able to read messages from new types of sensors. Even unforeseen data types are compatible with the system as long as the message is encoded into XML.

In the following description, a system which manages the cooling of a computer-based data management center is used as a specific example of a distributed sensor system. In a computer-based data management center, a large number of computers and other electronic components may be arranged in racks. This arrangement of electronics tends to generate a large amount of heat especially during peak usage times. In order to dissipate this heat, Heating, Ventilating and Air Conditioning (HVAC) equipment cools the data center facility. HVAC equipment may include heat pumps, air handlers, humidifiers, chillers, refrigeration units, and other components. The operation of these components can consume a large amount of energy. By sensing and analyzing the actual temperatures of computer components within the data center, the HVAC equipment can be more precisely controlled to match the actual cooling needs of the data center.

In order to know when HVAC equipment energy consumption can be curtailed, knowledge of the temperature at various points within the data center is needed. For example, large data centers may have several thousand racks containing computer components, making the setup of an efficient cooling system time consuming and expensive. Therefore, the following specification presents a method and system for gathering data from a large number of temperature sensors spread over the area of a data center.

According to one illustrative embodiment, the system is made up of several modular nodes which collect data through attached sensors, an Ethernet network over which data is sent, and a central processor which receives and organizes data from the modular nodes. Modular nodes are smart and can manage multiple sensors, receive configuration instructions from the central processor, and verify proper system operation. Instructions and data are sent between the modular nodes and the central processor through the IP multicasting protocol. IP multicasting allows a single communication channel to be used to communicate with a large number of listeners. In this example messages sent over the network are formatted in XML. The system is described below in greater detail.

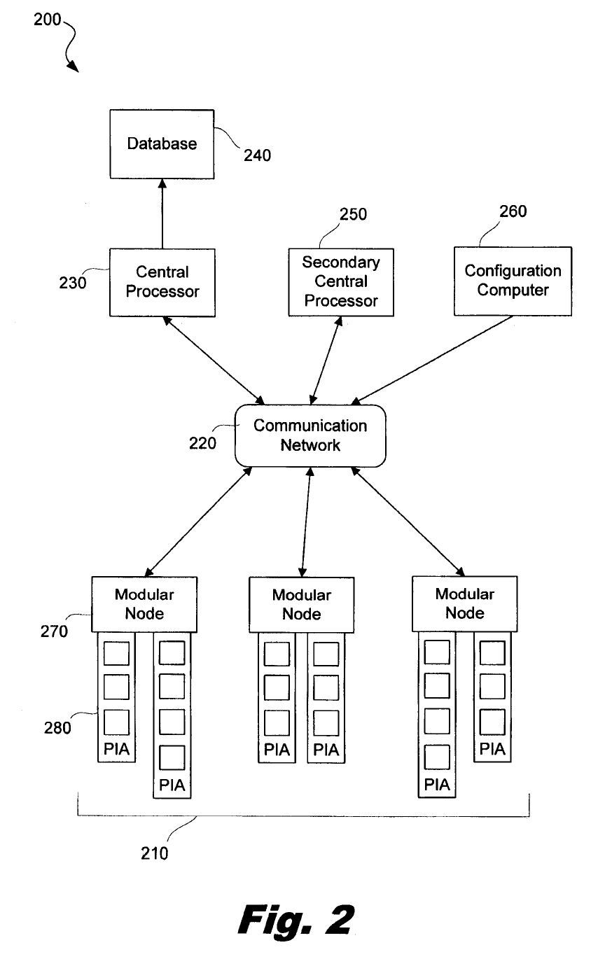

FIG. 2 is a diagram of a distributed sensor system (200) comprising one or more data collection assemblies (210), an Ethernet network (220), and a central processor (230). In some embodiments, the system may also include a database (240), a secondary central processor (250), and a configuration computer (260).

Each of the data collection assemblies includes a modular node (270) and a plug-in assembly (PIA) of one or more sensors (280). In this particular example, the sensors (280) could be temperature sensors attached to racks of electronic equipment that are being cooled with an HVAC system that is controlled by, or in communication with, the distributed sensor system (200).

Each modular node (270) collects data from the plug-in assembly of sensors (280) and sends it to the central processor (230) through the communication network (220). In this particular example, the central processor (230) receives messages from each modular node (270), extracts sensor data from the messages and stores the data in the database (240). By way of example and not limitation, the database (240) may be accessed by a controller program, a web based application, or any other component or entity that may be interested in the sensor data.

The secondary central processor (250) may act as a backup if the central processor (230) malfunctions. The configuration computer (260) may be used for sending configuration instructions to the data collection assemblies (210). By way of example and not limitation, the central processor (230) could be combined with the configuration computer (260) into a single entity.

The communication network (220) can a wired or wireless network. Examples of a wired communication network may include Universal Serial Bus (USB) or Ethernet. Any other type of networking connections may also be used. In the illustrated example, the communication network (220) is an Ethernet network because of the various benefits Ethernet technology offers to a distributed sensor system. For example, the distributed sensor system (200) may make use, in whole or in part, of an existing Ethernet network that has already been deployed for other purposes.

Additional elements could be added to an existing Ethernet network to support the functions of a distributed senor or data collection system. This may reduce the cost of creating the distributed sensor system because a network specifically dedicated for distributed data collection does not need to be installed. This also allows the system to be more easily relocated, if necessary.

Ethernet traffic can be routed through multiple pieces of network hardware before reaching its destination. Although there are limits to the length of a single connecting cable, this routing helps prevent limitations on the overall size of the network. Thus, Ethernet technology allows distributed sensor systems to cover a larger physical area.

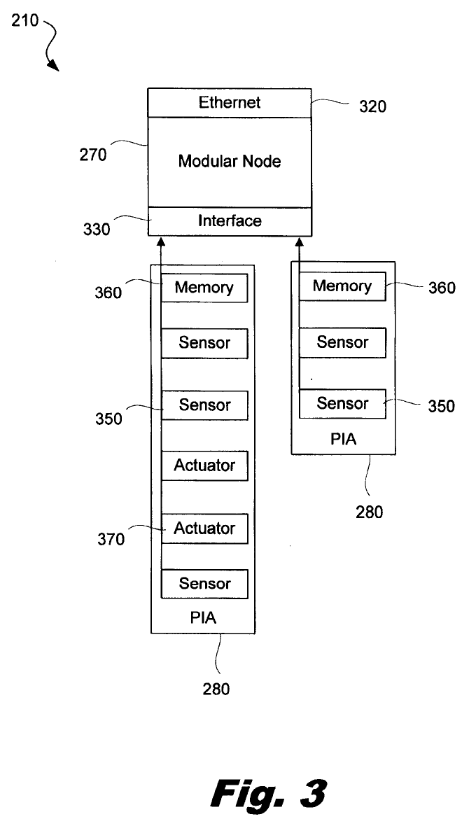

Ethernet also allows multiple devices attached to the network to send messages at the same time. This allows each modular node (270) to send data to the central processor (230) at will and eliminates the need for polling. The central processor (230) can consequently spend more time processing data, and sensors can be added to the network without sacrificing temporal resolution of the data. In the illustrated example, the sensors (280) are grouped together on a PIA that is managed by a corresponding modular node (270). As shown, a single modular node (270) may support multiple PIAs. The modular node (270) and attached PIA (280) constitute a data collection assembly (210), which is further explained with reference to FIG. 3.

FIG. 3 is a diagram of a data collection assembly (210), comprising a modular node (270) and one or more plug-in assemblies (PIA) (280). In the illustrated example, the modular node (270) has an Ethernet connection (320) for communication with the central processor (230, FIG. 2). By way of example and not limitation, this Ethernet connection (320) could be replaced with a wireless network adapter or other networking technology.

The modular node (270) has an interface (330) for communication with a number of Plug In Assemblies (PIAs) (280). In the illustrated example, the interface (330) may be a 1-wire interface. A 1-wire interface may contain separate conductors for ground and communication. However, the same conductor can be used for both power and communication, hence the name “1-wire interface.” A simple 1-wire interface may be used because, in any particular PIA (208), there are generally few enough sensors (350) that the modular node (270) can typically read them all in a short amount of time.

The use of a 1-wire interface is, however, only one example of a possible method for connecting the sensor PIA (280) to a modular node (270). A variety of network topographies and communication standards could be used. By way of example and not limitation, the system may be configured to use a differential balanced line over a twisted pair as described by RS-485 or EIA-422 specifications. In other embodiments, a serial peripheral interface (SPI) bus or controller area network (CAN) protocols may be used. The power required by the sensor PIAs (280) could be supplied by the signal cable or supplied by additional conductors integrated into or separate from the cable.

Each PIA (280) contains one or more sensors (350) and a memory block (360). The sensors (350) in the PIA (280) do not necessarily have to all be of the same type. In alternate embodiments, PIAs (280) may contain actuators (370) or a combination of sensors (350) and actuators (370). An actuator (370) can be any device that generates force or motion to affect its environment. In some examples, actuators (370) may support the sensors (350) by causing the environment to respond to applied force or motion in a way that is detected by the sensor (350). For example, actuators (370) can be, but are not limited to, piezoelectric devices, bimorphic elements, electric motors, hydraulic pistons, pneumatic actuators, or electric valves.

The PIAs (280) can be easily removed from or attached to the modular node (270), allowing identical modular nodes (270) to be used in a variety of applications. The memory block (360) is programmed to store data about the PIA (280) that is used by the modular node (270) and the central processor (230, FIG. 2). For example, the memory block (360) may contain an identification or part number of the PIA (280), an identification of the type and/or function of the sensors (350) or actuators (370) included in the PIA (280) and definitions of the data produced by the sensors (350) of the assembly (280). Consequently, the modular node (270) can read the memory block (360) to determine what sensors are attached and how to read their data. As illustrated, the modular nodes (270) are typically placed at, or in close proximity to, the location where data is to be collected.

As noted above, for context, an illustrative distributed sensor system is being discussed in the context of a temperature sensor system for a data center including electronic data processing equipment that is being cooled by an HVAC system. In this particular example, the sensors (350) are placed at various locations where cooling air enters or exits the racks of electronic equipment. For example, cooling fans may blow air through the front of the rack, while air heated by the equipment in the rack exits from the rear. The sensors (350) may be disposed to measure the temperature of the air entering and exiting the rack. The differential in temperature between air entering and exiting the rack may be used as an indicator of how hot the equipment in the rack is and how much cooling is needed. The modular node (270) collects this temperature data from the PIAs (280), through the interface (330) and sends it to the central processor (230, FIG. 2) over the network (220, FIG. 2).

Returning to FIG. 2, by automatically collecting and sending data to the central processor (230), the modular nodes (270) allow the central processor (230) to devote more resources to processing data rather than collecting it, e.g., polling for it. Modular nodes (270) can also verify proper operation of the network. The central processor (230) can be configured to periodically send out a “heartbeat” message to all modular nodes (270) through the network (220). This message allows the modular nodes (270) to verify that the central processor (230) is still functioning.

In some embodiments, if the central processor (230) malfunctions and stops distributing the “heartbeat” message, the modular nodes (270) can detect the lack of a heartbeat, and generate a visual, or other type of alarm, alerting users to the problem. By way of example and not limitation, the alarm signal generated by the modular node (270) when an error condition is detected could be simply turning on a light emitting diode (LED) located at the modular node (270). In this way, the health of the central processor (230) may be observed throughout the distributed sensor system (200).

If a secondary central processor (250) is available, the secondary central processor (250) may take over operation of the system (200) upon malfunction of the primary processor (230). This may be done automatically or selectively based on user control. There may be different LED flashing sequences or different color LEDs to indicate different types of error conditions, such as whether a secondary central processor (250) has taken over control of the system (200).

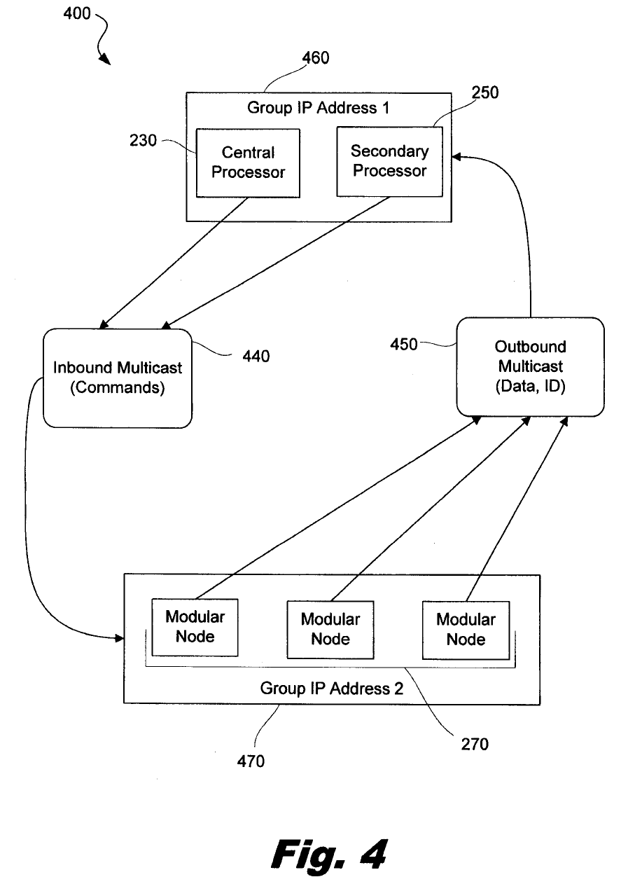

FIG. 4 is a diagram of communication (400) between various components of a distributed sensor system including a central processor (230), modular nodes (270) and a secondary processor (250). FIG. 4 illustrates, for example, an inbound communication channel (440) and an outbound communication channel (450). The inbound communication channel (440) represents data coming to the modular nodes (270). The outbound communication channel (450) represents data coming from the modular nodes (270).

Sending a single message to multiple receivers is accomplished through IP multicasting. IP multicasting is a standard network communication protocol which allows a single group IP address to be assigned to a large number of devices rather than having a unique IP address for each device on the network. In this particular example, one group IP address (460) is assigned to the processors (230, 250) (also referred to as data collectors), and another different IP address (470) is assigned to the modular nodes (270).

These IP addresses (460, 470) correspond to the different communication channels. For example, a message directed to group IP address 1 (460) belongs to the outbound communication channel (450). Similarly, messages sent to group IP address 2 (470) belong to the inbound communication channel (440). The modular nodes (270) send data over the outbound communication channel (440). The central data collector (420) and the optional secondary processor (250) send commands over the inbound communication channel.

Multicasting allows the central processor (230) to communicate with every modular node (270) simultaneously. For example, the central processor (230) may need to perform a mass configuration of all modular nodes (270). A single message containing configuration information can be sent through the inbound communication channel (440). All modular nodes (270) will receive the message and configure themselves according to the instructions. This greatly simplifies the task of sensor network configuration, because, rather than configuring each modular node (270) individually, the nodes (270) can all be configured at once. IP multicasting also allows modular nodes (270) to send data to multiple data collectors (e.g., processors (230) and 250)) with a single message. The process for collecting data remains unchanged no matter how many data collectors are receiving data. One exemplary embodiment of the data collection process is explained below.

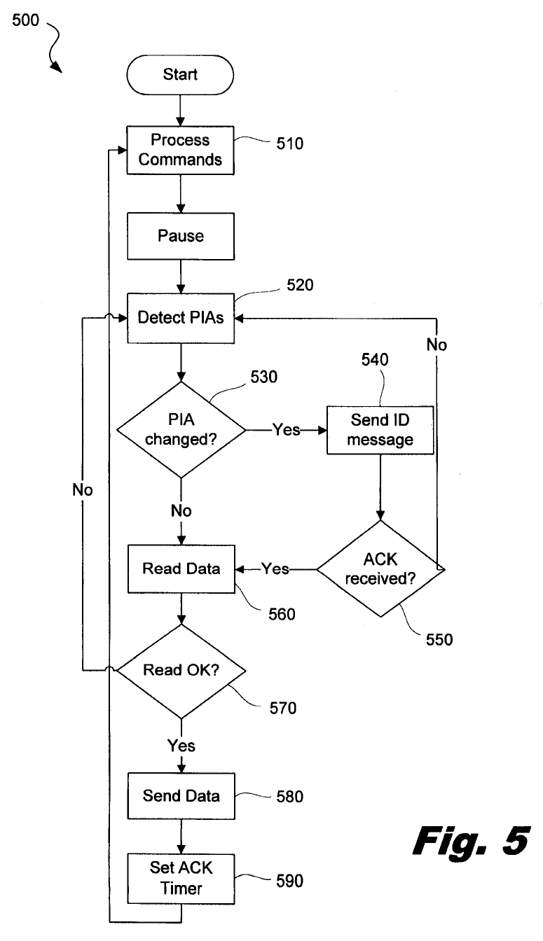

FIG. 5 is a flow chart which depicts an illustrative data collection procedure (500) for a modular node. As will be appreciated by those skilled in the art, the various steps shown in FIG. 5 are exemplary only and may be changed or reordered as best suits a particular application.

In the illustrated example, the first state of the modular node may be a pause state (step 510). During the pause state (step 510), the modular node may be waiting to begin the next data collection cycle or waiting for instructions from a central processor. In some embodiments, the time between data collection cycles for the modular node can be dynamically controlled by the central processor. This allows the system to adapt to situations where, for example, it may be useful to collect data only once every hour, while in other situations is may be useful to collect data once every second.

When a data collection cycle begins, the central processor may first detect the PIAs (step 520). During this step, the modular node which is cycling reads the memory block on the PIA. Each PIA connected to the modular node may have an address or identifier which serves as a unique identifier for that PIA.

In the next step (step 530), the modular node checks to see if the attached PIAs have changed (step 530). If the PIAs have changed, an identification (ID) message is sent to the central processor (step 540). The ID message contains information about the PIAs now attached to the modular node and allows the central processor to be prepared for the type of data that will be transmitted. An ID message may also be sent each time a modular node is connected to the network or rebooted, a new PIA is connected to the node, or whenever an ID message request is received. With the PIA memory module (360, FIG. 2) and the PIA detection step (step 520) and ID message step (step 540), the PIAs become readily hot swappable within the distributed sensor system.

After sending the ID message (step 540), the modular node waits for an acknowledge message (ACK) from the central processor (step 550). If the ACK message does not arrive after a defined amount of time, the modular node may return to detecting the PIAs (step 520) and repeat that portion of the process until an ACK message is received. This loop ensures that the central processor will always know in advance what kind of data to expect from a modular node. If the modular node sends information from changed PIAs without an ACK message, the central processor may be confused by the data.

Once an ACK message is received, or if the PIAs have not changed, the modular node proceeds to read data (step 560) from the sensors. After reading data (step 560), the modular node verifies that that data was read correctly (step 570). A read error may occur if a PIA is changed after PIA detection (step 520) and before reading data (step 560). If there was an error in reading, the modular node goes back to Detect PIAs (step 520) and repeats the process again. If data was read correctly, the modular node sends the data to the central processor (step 580). The node may combine data from multiple sensors into a single message to the central processor.

In the illustrated example, messages to the central processor are encoded using extensible Markup Language (XML). Among other benefits mentioned earlier in this specification, XML may help reduce data message overhead. Data sent over the network is padded with information used to direct it to the proper destination, much like a letter is inserted into an envelope to be mailed. If data from each sensor is sent separately, there is much more overhead than if data from a number of sensors is combined into a single message. XML allows any amount of data to be included in a single message, thereby reducing message overhead.

According to one exemplary embodiment, only changes in the sensed data are transmitted to the central data collector by the modular node. For example, a modular node may be connected to ten temperature sensors. Nine of the temperature sensors report that the temperature at their location has not significantly changed, while one sensor reports an increase in temperature. In this embodiment, the modular node will only report the increase in temperature at the single node. In such an embodiment, the central processor may be programmed to assume that other temperatures have not changed significantly.

After sending data, the modular node sets the ACK timer (step 590) and pauses (step 510) to wait for instructions or the next data collection cycle. The ACK timer is set to allow the watchdog process to detect an error situation. A watchdog process monitors the timer. If the timer expires before the central processor sends an ACK message, the node raises an alarm signal which is detected by the modular node.

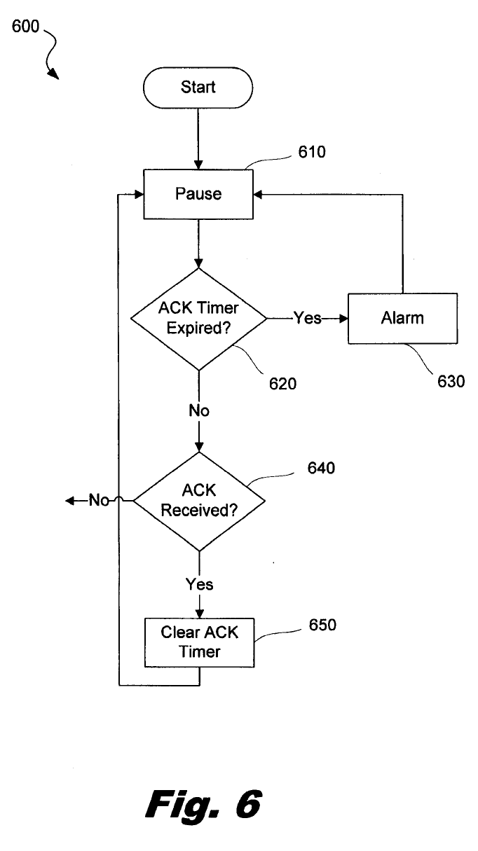

FIG. 6 is a flow chart which depicts the modular node's watchdog process (600). The watchdog process (600) remains in a pause (step 610) state and periodically checks to see if an ACK signal has arrived from the central processor. The watchdog first checks to see of the ACK timer has expired (step 620). The ACK timer is set each time the modular node sends a message to the central processor. If the timer has expired, the watchdog raises an alarm (step 630) and returns to the pause state (step 610). The alarm may be handled by the modular node in a variety of ways depending on the situation. It may repeat the message that failed to receive an ACK message or it may simply raise an outside alarm, alerting users to the situation. If the timer has not expired, the watchdog checks for an ACK message (step 640) from the central processor. If an ACK message has not been received the watchdog returns to pause (step 610) and repeats the process. If the ACK message has arrived, the watchdog clears the ACK timer (step 650) and returns to the pause state (step 610).

This and similar watchdog processes help the modular node detect errors in communication and ensure proper operation of the system. This allows users of the system to be quickly notified if a problem occurs. In a related example, if the heartbeat signal described above stops coming from the central processor, the watchdog timer associated with heartbeats will expire and raise an alarm. This can alert system administrators to a possible problem with the central processor.

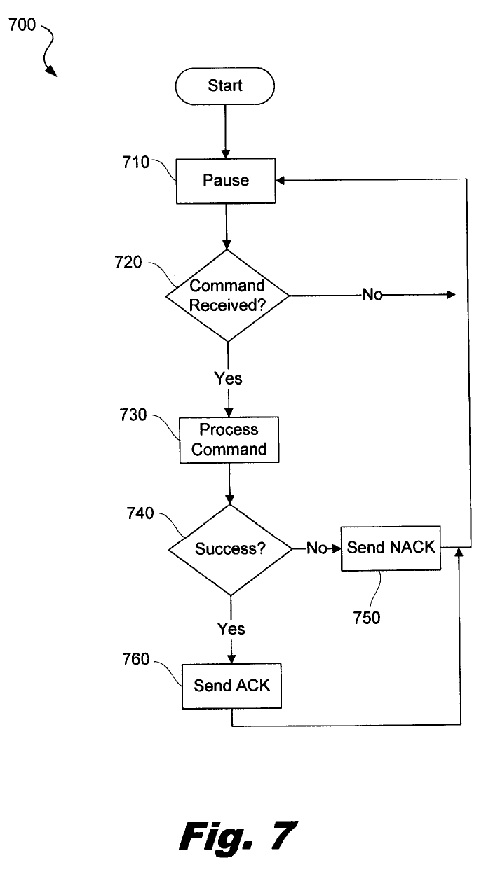

FIG. 7 is a flow chart which depicts the modular node's command receiving process (700). The process (700) pauses (step 710) and periodically checks for commands (step 720). If a command has not been received the process returns to the pause state (step 710). If a command is received, it is processed (step 730). Commands may be a request for an ID message, configuration commands, or other commands. The process then verifies that the command was completed successfully (step 740) and sends and ACK message (step 760). If the command was not completed successfully, it sends a Not Acknowledge (NACK) message to the central processor (step 750). The ACK/NACK messages allow the central processor to verify that commands were received and executed by a node, and to send them again if necessary. ACK messages helps to ensure proper operation of the system by verifying that commands were received and executed successfully. This allows the central data processor to confirm that modular nodes are configured properly.

The ability of the modular nodes to receive commands allows sensors to be configured from a remote location. This helps in initial setup and configuration of the sensors and periodic reconfiguration of the sensors at a future time. Reconfigurations can be done without having to go to the physical location of each sensor assembly. A similar process to the command receiving process is used by the central processor to receive data messages from the modular nodes. This process is described below.

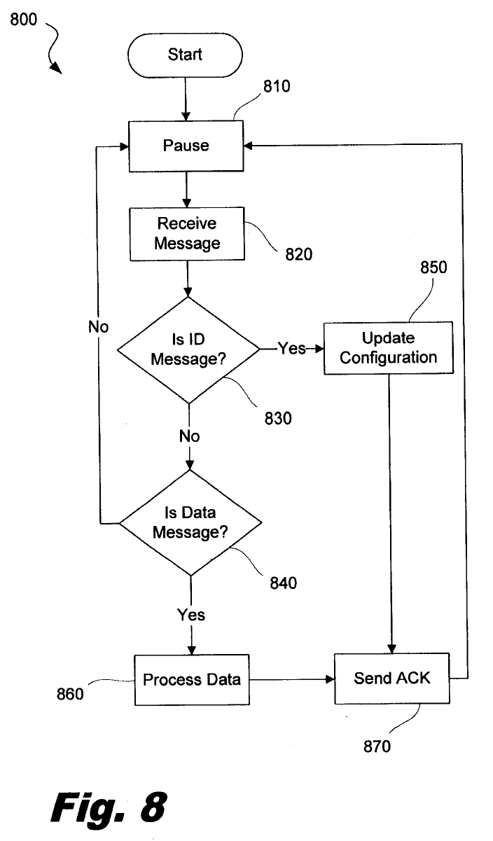

FIG. 8 a flow chart which depicts a message receiving process (800) of the central processor. The process (800) pauses (step 810) and waits until a message is received (step 820). After receiving a message, the process checks to see if it is an ID message (step 830) or data message (step 840). In this particular example, if the message is not an ID message and it is not a data message, it is invalid and the process returns to the pause state (step 810) to wait for a valid message. If the message in an ID message, the central processor updates a stored configuration (step 850) using the data in the ID message so that the central processor can properly handle the sensor data to be received.

Once the configuration is updated, the central processor sends an ACK (step 870) to the modular node from which the ID message was received. In this case, the ACK message is not received by all modular nodes. Even though all modular nodes have the same IP address, messages can be addressed to one particular modular node using a unique identifier embedded within the message itself. Modular nodes will check for this unique identifier within messages and will not process an ACK message intended for another modular node.

If the message received by the central processor is a data message, the central processor processes the sensor data (step 860). This may include updating a sensor data database. Once the central processor has processed the data (step 860), the central processor may, in some embodiments, send an ACK (step 870) to the node that sent the data message. The acknowledgment of all messages helps maintain the quality of data and detect error conditions by verifying that data sent by the modular nodes was in fact received by the central processor.

In this particular example, the central processor stores sensor data in a database. A separate control program reads the data and uses it to make decisions about which environmental parameters to adjust. For example, the control program may control fan speed. In such a case, if the temperature in rack A exceeds a threshold, the control program will increase air flow for that rack. Similarly, if rack B drops below a certain temperature threshold, the control program will turn down the cooling fan to conserve energy. This allows cooling to be done more efficiently, reducing the cost of operation, and possibly extending the life of equipment. By way of example and not limitation, the collection of data, processing, and decision making, could all be done by a single entity.

Since, the central processor does not have to request and wait for data, it can allocate more time to processing data. This allows a central processor to handle more data from more sensors, raising the limit on the number of sensors that can be deployed in the network. By way of example and not limitation, if the data processing ability of the central processor is exceeded by the amount of data coming in over the network, a second central data collector could share the task of processing data. In another embodiment, the tasks of extracting data from the XML messages and processing the data could be split between two separate machines.

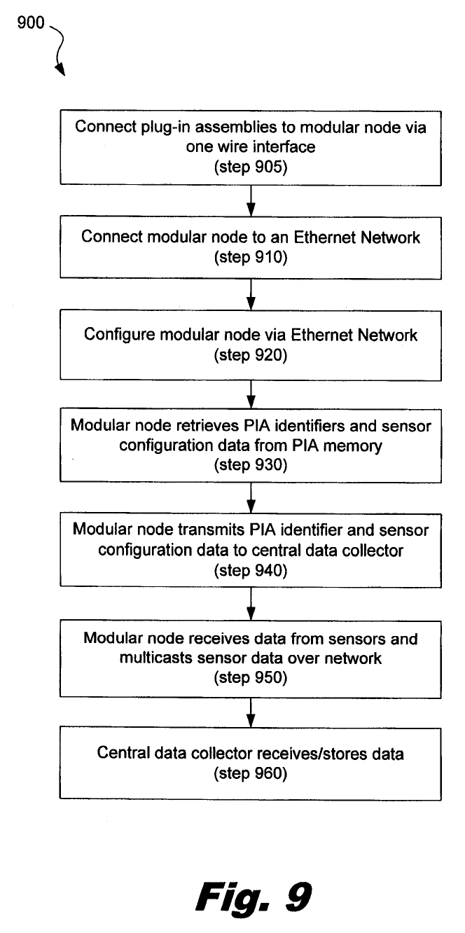

FIG. 9 is a flow chart showing one illustrative method (900) of assembling and using a distributed sensor system. In a first step the plug-in assemblies (PIAs) are connected to modular nodes (step 905). Multiple PIAs may be connected to a single modular node. In one exemplary embodiment, the PIAs comprise a one-wire interface which is physically attached to the modular node. By way of example and not limitation, the one wire interface may be connected to the modular node via a screw terminal or keyed connector.

The modular node is then connected to an Ethernet network (step 910). The modular node is then in communication with a configuring entity and can be remotely configured by receiving appropriate instructions (step 920). After configuration, the modular node retrieves PIA identifiers and sensor configuration data that is stored in the PIA memory (step 930) and transmits the identifiers and configuration data to the central processor (step 940). This information allows the central processor to properly interpret, analyze and store the sensor data from the modular node.

The modular node then receives data from the PIA sensors and multicasts the sensor data over the network (step 950). The central processor receives and stores the data (step 960).

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A distributed sensor system comprising:
a plug-in attachment, said plug-in attachment comprising a memory and at least one sensor;
a modular node, said plug-in attachment being configured to connect to said modular node, said modular node being configured to read said memory and receive sensor data from said at least one sensor;
a network, said network being connected to said modular node; and
a central processor, said central processor being connected to said network and being in communication with said modular node through said network.

2. The system of claim 1, wherein said memory contains configuration information identifying said plug-in attachment and sensor configuration.

3. The system of claim 2, wherein said modular node automatically detects said plug-in attachment by reading said configuration information.

4. The system of claim 2, wherein said modular node transmits said configuration information and said sensor data to said central processor, said central processor using said configuration information to interpret and analyze said sensor data.

5. The system of claim 1, wherein said distributed sensor system comprises a plurality of modular nodes, said plug-in attachment being hot swappable between any of said plurality of modular nodes.

6. The system of claim 1, wherein said plug-in attachment further comprises an actuator.

7. The system of claim 1, wherein said plug-in attachment connects to said modular node via a one wire connection.

8. The system of claim 1, wherein said modular node is configured to receive and respond to identification requests and configuration commands from said central processor.

9. The system of claim 8, wherein said modular node is further configured to send an acknowledgement message to said central processor acknowledging receipt and execution of said identification requests and configuration commands.

10. The system of claim 9, wherein said central processor is configured to trigger an error state when said acknowledgement message is not received within a predetermined period of time.

11. The system of claim 1, wherein said modular node is configured to use internet protocol address multicasting to broadcast said sensor data over said network.

12. The system of claim 1, wherein said modular node is configured to detect and report errors to said central processor.

13. The system of claim 1, wherein said system comprises a plurality of modular nodes, said central processor being configured to send mass configuration information to a plurality of said modules using internet protocol address multicasting.

14. The system of claim 13, wherein said central processor is further configured send messages to a specific modular node by including information identifying said specific modular node in a multicast message.

15. The system of claim 1, wherein said central processor is further configured to write said sensor data to a database.

16. A system for collecting data from distributed sensors comprising:
at least one plug-in assembly, said plug-in assembly comprising sensors and a memory module, said memory module containing a unique identifier for said plug-in assembly and sensor configuration data;
at least one modular node for receiving said plug-in assembly, said modular node automatically detecting said plug-in assembly when connected by retrieving said unique identifier and said sensor configuration data, said modular node being configured to independently collect and transmit sensor data from said sensors, wherein said plug-in assembly is hot swappable;
a central processor;
an Ethernet network connecting said modular node to said central processor, wherein communication between said modular node and said central processor is done through internet protocol address multicasting and wherein said communication comprises messages formatted in extensible markup language.

17. A method for configuring and using a distributed sensor system comprising:
connecting at least one plug-in assembly to a modular node, said at least one plug-in assembly comprising a memory and at least one sensor, said memory containing configuration data;
connecting said modular node and a central processor to a network;
configuring said modular node via said network;
said modular node retrieving said configuration data and sending said configuration data via said network to said central processor;
said modular node receiving sensor data from said at least one sensor, said modular node transmitting said sensor data via said network to said central processor.

18. The method of claim 17, wherein internet protocol multicasting is used for communication of messages over said network, said messages being written in extensible markup language.

19. The method of claim 17, wherein said central processor receives said configuration data, said central processor using said configuration data to interpret and analyze said sensor data.

20. The method of claim 17, wherein said network at least partially comprises existing network infrastructure not initially installed for said distributed sensor system.
